(19) United States
(12) Patent Application Publication
(10) Pub. No.: US 2004/0235521 A1
(43) Pub. Date: Nov. 25, 2004

(54) Method and system for exchanging digital media

(76) Inventors: Salil Pradhan, Santa Clara, CA (US); Christophe Gouguenheim, Mountain View, CA (US); Bill Serra, Montara, CA (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/428,810

(22) Filed: May 1, 2003

(51) Int. Cl. H04B 1/38; H04M 1/68

(52) U.S. Cl. 455/558; 455/411

(57) ABSTRACT

The present invention includes a method and system for exchanging digital media. According to the present invention, a method and system includes transmitting access rights between system users wherein the access rights allow access to certain types of transferable media. The access rights can be transmitted by paying a fee to the transmitting user. A first aspect of the present invention includes a method of exchanging digital media. The method includes receiving a user identifier, securely accessing device based on a first transaction between the user identifier and the device and allowing the device to transmit at least one access right to a media to the user identifier based on a second transaction between the user identifier and the device.

### FIELD OF THE INVENTION

The present invention relates generally to the field of delivering digital entertainment media, and more particularly to a method and system for exchanging digital media.

### BACKGROUND OF THE INVENTION

The Internet is changing the distribution of music and video content. Recent advances in audio and video compression, higher bandwidth Internet connections, and the decreasing cost of memory have made it practical for users to download audio and video content via the Internet to personal computers and other dedicated digital devices. The downloaded content can also be transferred to CDs, mini-discs, or digital video discs and played on other audio and video devices such as MP3-format digital players. MP3 (MPEG Audio Layer-3) format is a compression system for digital music that helps reduce the size of a digitized song without degrading the sound quality.

Digital music converted to MP3 format is currently available on the World Wide Web for individual use. MP3 files can be downloaded from the Internet using a computer and special software. Furthermore, a personal computer programmed with the appropriate software can covert digital music from a CD (compact disk) into MP3 format. Currently, MP3 files can be played in three different ways: (i) MP3 files can be played directly on a personal computer, (ii) MP3 files can be decompressed and recorded it onto a CD, and (iii) the MP3 files can be played on an MP3 player. MP3 players are relatively small, lightweight, portable devices that can interface with a personal computer. Thus, a user can download MP3 files from the Internet and load such MP3 files onto the MP3 player. Typically, the MP3 player can be connected to the personal computer's parallel or USB port in order to receive the downloaded MP3 files.

FIG. 1 is an illustration of a conventional system 100 for exchanging digital media. The system 100 includes an MP3 player 110 and a computer system 120. Accordingly, the MP3 player 110 is coupled to the computer system 120 wherein the computer system 120 is coupled to the Internet 130. Typically, a user who wishes to download a particular song or video via the Internet 130 searches for the title at a web site 135, finds the title, and requests that it be downloaded. A digital file containing the requested content is then transferred to the computer system 120 using a File Transfer Protocol (FTP) and stored within a memory component in the computer system 120. The digital file can then be transferred from the computer system 120 to the MP3 player 110.

This practice of downloading media from the Internet, particularly music, has been the source of much controversy. Peer-to-peer software such as Napster, Morpheus and Kaza have been utilized to provide consumers with the ability to freely share copyrighted digital media. In a sense, such software makes it possible for consumers to arguably commit intellectual property theft with relative ease. As a result, consumers have little or no motivation to go to a record store and purchase CDs, albums or the like when they can simply download the desired music via the web site. Needless to say, media providers, as well as the creators of the music, are opposed to such practices since they do not receive any financial compensation when the copyrighted digital media is downloaded and transferred between the users of the web sites.

Accordingly, what is needed is a method and system that addresses the problems related to the transfer of digital media amongst consumers. The method and system should be simple, cost effective and capable of being easily adapted to existing technology. The present invention addresses these needs.

### SUMMARY OF THE INVENTION

The present invention includes a method and system for exchanging digital media. According to the present invention, the method and system includes transmitting access rights between system users wherein the access rights allow access to certain types of transferable media. The access rights can be transmitted by paying a fee to the transmitting user and the media provider. By utilizing the method and system in accordance with the present invention, system users are encouraged to share media, while at the same time, media providers can receive a fee for each transaction between system users thereby eliminating the theft of intellectual property rights related to the media.

A first aspect of the present invention includes a method of exchanging digital media. The method includes receiving a user identifier, securely accessing a memory component of a device based on a first transaction between the user identifier and the device and allowing the device to transmit at least one access right to a media to the user identifier based on a second transaction between the user identifier and the device.

A second aspect of the present invention includes a system for exchanging digital media. The system includes a user identifier wherein the user identifier includes a memory portion, a first device wherein the first device includes a first mechanism for accessing the memory portion of the user identifier and a memory component wherein the memory component includes at least one access right to a media. The system further includes a second device wherein the second device includes a second mechanism for accessing the memory portion of the user identifier wherein the second device is capable of accessing the media.

A third aspect of the present invention includes a device for exchanging digital media. The device includes a memory component for storing at least one encrypted media file, a media card reader coupled to the memory component and a central processing unit coupled to the memory component and the media card reader wherein the central processing unit includes logic for processing an access right based on a transaction between the media card reader and the central processing unit.

A fourth aspect of the present invention includes a method of purchasing digital media. The method includes allowing a first device to securely access a second device, transmitting an access right to a media from the second device to the first device and transmitting a medium of exchange from the first device to the second device in response to the transmission of the access right to the media.

A fifth aspect of the present invention includes a computer program product for exchanging digital media. The computer program product includes a computer usable medium having computer readable program means for causing a computer to perform the steps of allowing a device to access a user identifier based on a first transaction between the user identifier and the device and allowing the device to transmit at least one access right to the user identifier based on a second transaction between the user identifier and the device.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is an illustration of a conventional system for exchanging digital media.

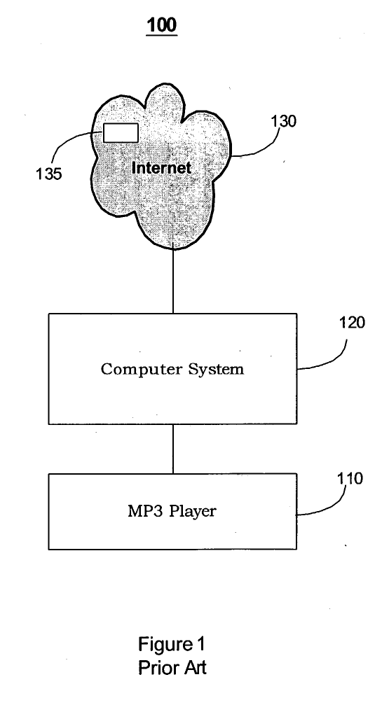

FIG. 2 is a flowchart of a method in accordance with an embodiment of the present invention.

FIG. 3 illustrates a media card that could be utilized in conjunction with a method in accordance with an embodiment of the present invention.

FIG. 4 is an illustration of a hot spot in accordance with an embodiment of the present invention.

FIG. 5 is a flowchart in accordance with an alternate embodiment of the present invention.

FIG. 6 is a block diagram of an MP3 player that could be utilized in conjunction with an alternate embodiment of the present invention.

FIG. 7 is a flowchart in accordance with an another embodiment of the present invention.

FIG. 8(a) is an illustration in accordance with an alternate embodiment of the present invention.

FIG. 8(b) shows the transmission of a media file and the associated decryption key from the second MP3 player to the first MP3 player in accordance with an alternate embodiment of the present invention.

FIG. 8(c) shows the transmission of the digital tokens from the first MP3 player to the second MP3 player in accordance with an alternate embodiment of the present invention.

FIG. 9 shows a flowchart of a method in accordance with an alternate embodiment of the present invention.

FIG. 10 shows a car audio system in accordance with an embodiment of the present invention.

FIG. 11 is a flowchart of program instructions that could be contained within a computer readable medium in accordance with the alternate embodiment of the present invention.

### DETAILED DESCRIPTION

The present invention relates to a method and system for exchanging digital media. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

The present invention includes a method and system for exchanging digital media. According to the present invention, the method and system includes transmitting access rights between system users wherein the access rights allow access to certain types of transferable media. The access rights can be transmitted by paying a fee to the transmitting user and the media provider. By utilizing the method and system in accordance with the present invention, system users are encouraged to share media, while at the same time, media providers can receive a fee for each transaction between system users thereby eliminating the theft of intellectual property rights related to the media.

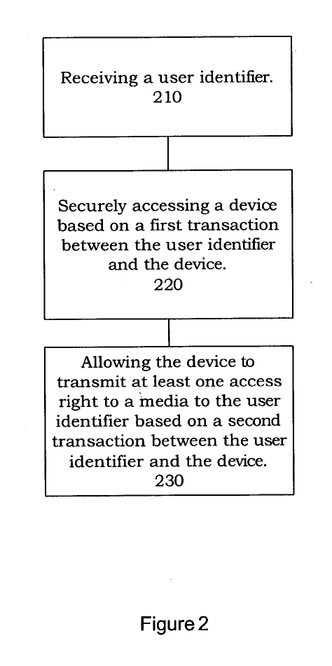

FIG. 2 is a flowchart of a method in accordance with an embodiment of the present invention. A first step 210 includes receiving a user identifier. The next step 220 includes securely accessing a device based on a first transaction between the user identifier and the device. In an embodiment, the first transaction includes a mutual authentication sequence. The final step 230 includes transmitting at least one access right to a media from the device to the user identifier based on a second transaction between the user identifier and the device. In an embodiment, the second transaction includes transmitting a medium of exchange from the user identifier to the device.

In an embodiment, the user identifier is a media card wherein the media card incorporates smart card technology. Generally speaking, smart cards are wallet-sized (or smaller) cards incorporating a microprocessor or microcontroller to store and manage data within the card. More complex than magnetic-stripe and stored-value cards, smart cards are characterized by sophisticated memory management and security features. Multi-function cards, for example, are often configured to support credit, debit, stored value, loyalty, and a number of other applications all within a single card. A typical multi-function smart card includes a microcontroller embedded within the card plastic which is electrically connected to an array of external contacts provided on the card exterior.

The smart card microcontroller generally includes an electrically-erasable and programmable read only memory (EEPROM) for storing user data, random access memory (RAM) for scratch storage, and read only memory (ROM) for storing the card operating system. Relatively simple microcontrollers are adequate to control these functions. Thus, it is not unusual for smart cards to utilize 8-bit, 5 MHZ microcontrollers with about 8K of EEPROM memory (for example, the Motorola 6805 or Intel 8051 microcontrollers).

A number of standards have been developed to address various aspects of smart cards, e.g.: ISO 7816-1, Part 1: Physical characteristics (1987); ISO 7816-2, Part 2: Dimensions and location of the contacts (1988); ISO 7816-3, Part 3: Electronic signals and transmission protocols (1989, Amd. 1 1992, Amd. 2 1994); ISO 7816-4, Part 4: Inter-industry commands for interchange (1995); ISO 7816-5, Part 5: Numbering system and registration procedure for application identifiers (1994, Amd. 1 1995); ISO/IEC DIS 7816-6, Inter-industry data elements (1995); ISO/IEC WD 7816-7, Part 7: Enhanced inter-industry commands (1995); and ISO/IEC WD 7816-8, Part 8: Inter-industry security architecture (1995). These standards are hereby incorporated by reference.

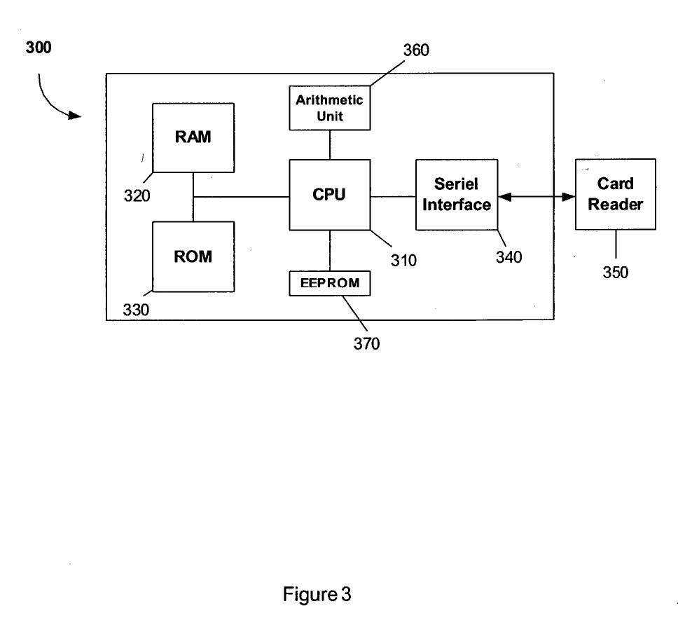

FIG. 3 illustrates a media card 300 that could be utilized in conjunction with a method in accordance with an embodiment of the present invention. The media card 300 includes a central processing unit 310 (CPU) which is connected to a read only memory 320 (ROM), primarily used for storage of an operating system. A random access memory 330 (RAM) is also provided for volatile storage of data, particularly for program execution. The CPU 310 is operatively coupled to a serial interface 340 that in turn communicates with a card reader 350 according to techniques well known in the art. The CPU 310 is connected to an arithmetic logic unit 360, for example, one suitable for processing large keys (512 byte keys, 1024 current RSA). An electrically erasable programmable read only memory 370 (EEPROM) is provided, which typically stores system files and applications. The media card 300 could be a compaq flash card or memory stick.

In an embodiment of the present invention, the media card is purchased by a user and is utilized to purchase access rights for different types of media. For the purposes of this patent application, an access right can be thought of as a pseudo-license to use the associated media. These access rights can be purchased with the media card whereby the media card is subsequently used in conjunction with a media-playing device to access the media. At the time the user purchases the media card, the user can purchase a number of digital tokens or any other medium of exchange, which can be later used to purchase access rights to media. For the purposes of identifying/authenticating users of media cards, a unique digital certificate can be stored into the card for the purpose of authenticating/identifying a user. Additionally, for an added security measure, a requirement could be established whereby the certificates have to be renewed after a predetermined amount of time (once a month, once a quarter, etc.) or after a predetermined number of transactions.

Furthermore, to make it possible to perform offline transactions, that is transactions made disconnected from the Internet infrastructure, a transaction log is maintained on the media card whereby each transaction made offline with the media card is recorded and stored in a local file. Accordingly, a user can defer the payment of the fee to the provider of the media when he performs an offline transaction. When this user will attempt to renew the card, i.e. renew the unique certificate, the system will check his transaction log and ask him to pay for his transactions made offline.

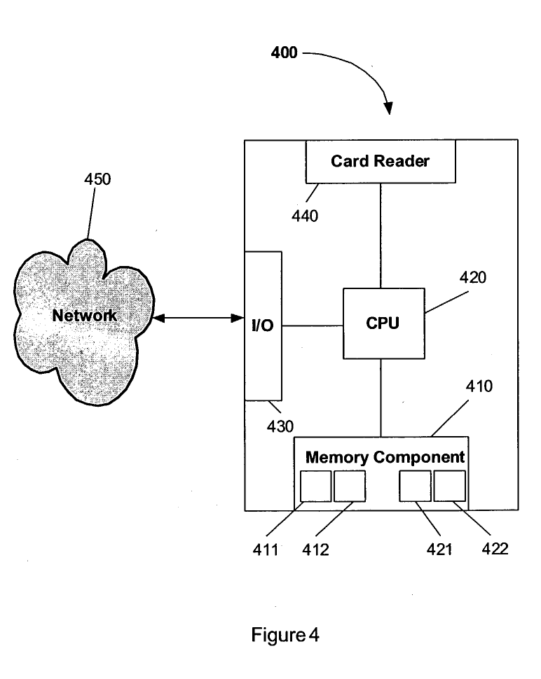

In an embodiment, the media card is utilized to purchase access rights to media from a hot spot device (“hot spot”). FIG. 4 is an illustration of a hot spot 400 in accordance with an embodiment of the present invention. The hot spot 400 includes a memory component 410, a CPU 420, a network interface 430 and a media card reader 440. The CPU 420 is coupled to the memory component 410, the network interface 430 and the media card reader 440. The network interface 430 is coupled to a network 450 whereby media files can be accessed and stored in the memory component 410.

The memory component 410 includes media files 411, 412 and the associated access rights 421, 422 thereto. In an embodiment, the media files 411, 412 are encrypted files containing various digital media (music, movies, etc.) and the associated access rights 421, 422 are decryption keys for decrypting the respective encrypted media files. For example, access right 421 is a decryption key for encrypted media file 411 and access right 422 is a decryption key for encrypted media file 412. Accordingly, a user must purchase the access right to an associated media file before the user can access the encrypted media file.

Encryption methods typically rely on “secret keys” known only to authorized users of the protected data. In the widely used Data Encryption Standard (“DES”) developed and promulgated by the National Bureau of Standards, data is encyphered in 64-bit blocks using a single 56-bit key, as described in National Bureau of Standards' Federal Information Processing Standards Publication 46, “Data Encryption Standard,” National Bureau of Standards (1977). Encryption techniques using two keys, one for encypting the data and a different key for decryption, are called “public key” systems because the encryption key can be made public so that anyone can use the public key to encrypt sensitive data, but only a recipient with the secret key can decrypt it. One widely used and highly effective public key algorithm is known as the “RSA” system, named after the inventors Rivest, Shamer and Adelman.

In an embodiment, the network 450 is the Internet. The Internet, which is a global web of interconnected computers and computer networks, integrates local area networks (LANs) located in various entities, such as businesses, libraries, federal agencies, institutes of learning, and research organizations into a single communication network. The Internet uses a common communication protocol suite, known as a Transmission Control Protocol/Internet Protocol (TCP/IP), which was specifically designed for the interconnection of different computer systems. Internal and external networks are linked by routers that route data packets from a sending network to another router or a receiving network. Gateways handle data transfer and conversion of messages from a sending network to the protocols used by a receiving network. Typically, gateways refer to devices that translate between applications. For example, e-mail gateways translate messages from one vendor's messaging program to another vendor's messaging program so that users with different e-mail programs can share messages over a network.

In an alternate embodiment, the network 450 is a private network for a media distributor (e.g. Sony Media, Tower Records, etc.). Accordingly, if the network 450 is a private network, the hot spot 400 only provides access rights to media that is distributed by the associated distributor. For example, if the hot spot 400 is coupled to a Sony network, then the hot spot 400 only provides access to Sony media.

Referring back to FIG. 4, in accordance with the present invention, a media card 450 is inserted into the card reader 440. A user authentication sequence then takes place to identify the user. The authentication of the user requires the exchange of messages between the media card 450 and the hot spot based on an authentication protocol. The authentication protocol helps the user to prove his identity to the hot spot 400 by demonstrating his knowledge of a secret (e.g. a password or PIN) that was previously established. A keypad may be needed (not shown) to enter into the hot spot 400 the user's secret password or PIN. Once the authentication sequence is completed, the user can purchase access rights to associated media files. At this point, the user selects the media she wishes to purchase and the access right to the media is downloaded to a memory portion of the media card 450. Digital tokens are then transmitted from the media card 450 to the hot spot 400.

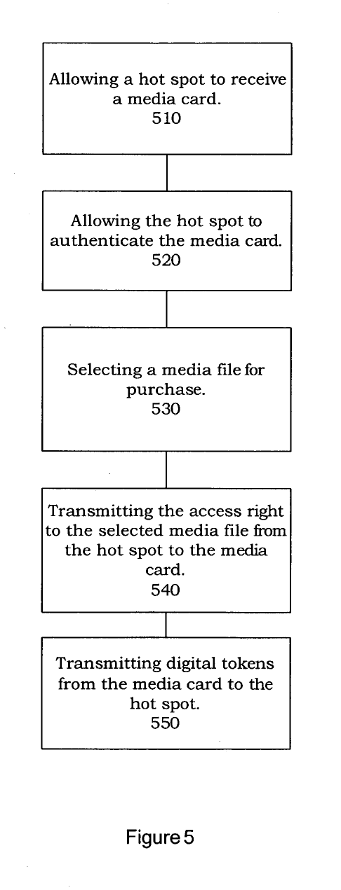

FIG. 5 is a flowchart in accordance with the above-described embodiment of the present invention. A first step 510 includes allowing a hot spot to receive a media card. A second step 520 includes allowing the hot spot to authenticate the media card. A next step 530 includes selecting a media file for purchase. A next step 540 includes transmitting the access right to the selected media file from the hot spot to the media card. In this embodiment, transmitting the access right includes transmitting a decryption key to the selected media. A final step 550 includes transmitting digital tokens from the media card to the hot spot.

At this point, the media card can be utilized in conjunction with a media-playing device to play the selected media. For example, if the hot spot is a juke box and the purchased media is a particular song, the media card can be inserted into the juke box and the user will be able to play the particular song based on the purchase of the associated decryption key.

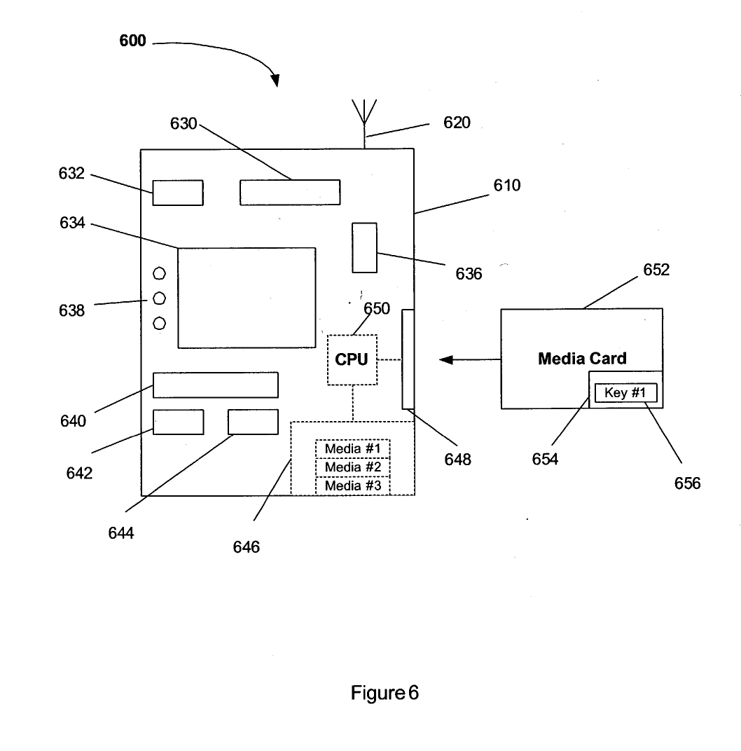

In an alternate embodiment, the media card can be utilized to play the media via a separate media-playing device. For example, an MP3 player could be utilized in conjunction with the media card to play the purchased media. FIG. 6 is a block diagram of an MP3 player 600 that can be utilized in conjunction with an alternate embodiment of the present invention. The player 600 generally comprises a housing 610, an antenna 620, a display 630, connect/disconnect function key 632, display 634, browse/select wheel or knob 636, function keys 638, keypad 640, “Play” function key 642, and “Stop Play” function key 644, an internal memory component 646, a media card reader 648 and an internal central processing unit (CPU) 650 wherein the CPU 650 is coupled to the memory component 646 and the media card reader 648.

Connect/disconnect function key 632 allows the user to establish or terminate data communication with a network. The user can use keypad 640 to input data which will appear in display 630. Display 634 displays information relating to titles or names of songs, musical compositions, types of music, e.g. jazz, classical, Hindustini, etc. The user uses browse/select wheel or knob 636 to select one or more titles shown in display 634. Function keys 638 provide several functions such as volume, bass, treble, DNR (Dolby.TM. Noise Rejection), etc. The user depresses function keys 642 and 644 to start and stop, respectively, play of music. Player 600 includes audio output devices (not shown) such as a speaker or head phone connector.

In an embodiment, the memory component 646 is a solid state component. A solid state component is an electronic component or circuit made of solid materials, such as transistors, chips and bubble memory. In an embodiment, the memory component 646 is a random-access memory (RAM) wherein the RAM can be a contiguous block of dynamic memory which may be selectively rewritten (e.g. flash RAM, hard drive memory, SRAM, DRAM, etc.).

Accordingly, a media card 652 is inserted into the card reader 648. A user authentication sequence then takes place to identify the user. The CPU 650 then checks a memory portion 654 of the media card 652 to determine the access rights (decryption keys) that are contained therein. Based on the decryption keys that are present in the memory portion 654 of the media card 652, the MP3 player is allowed to play particular media files. For example, the memory portion 654 of the media card 652 contains the decryption key 656 for media file 1. As a result, the MP3 player 600 is allowed to play media file 1. However, although the memory component 646 of the player 600 contains media files 2-3, the MP3 player 600 is not allowed to play media files 2-3 because the memory portion 654 of the media card 652 only contains the decryption key 656 for media file 1.

Although the above-described embodiment of the present invention is disclosed in the context of being utilized in conjunction with an MP3 player, one of ordinary skill in the art will readily recognize that a variety of different types of media-playing devices could be utilized while remaining within the spirit and scope of the present invention. For example, the media-playing device could be a television, a video-player, a DVD player, etc. while remaining within the spirit and scope of the present invention.

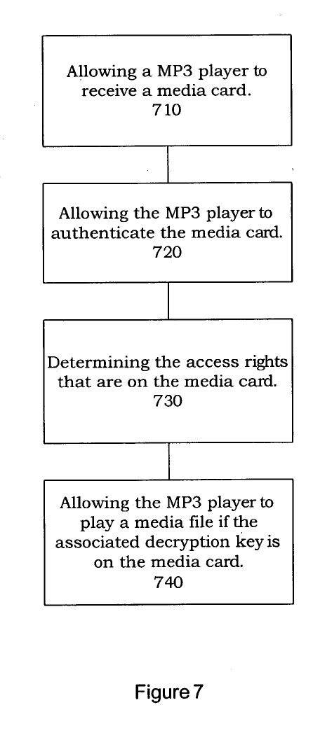

FIG. 7 is a flowchart in accordance with the above-described embodiment of the present invention. A first step 710 includes allowing a MP3 player to receive a media card. A second step 720 includes allowing the MP3 player to authenticate the media card. A next step 730 includes determining the access rights that are on the media card. In this embodiment, an access right is a decryption key to a media file. A final step 740 includes allowing the MP3 player to play a media file if the associated decryption key is on the media card. Again, because the MP3 player only stores encrypted media files, the MP3 player is only allowed to play media files that have an associated decryption key on the media card.

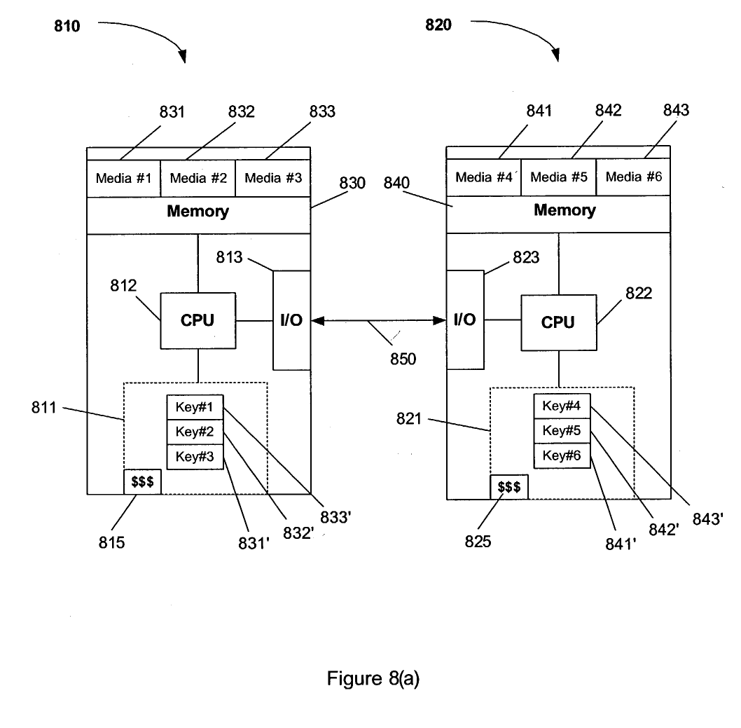

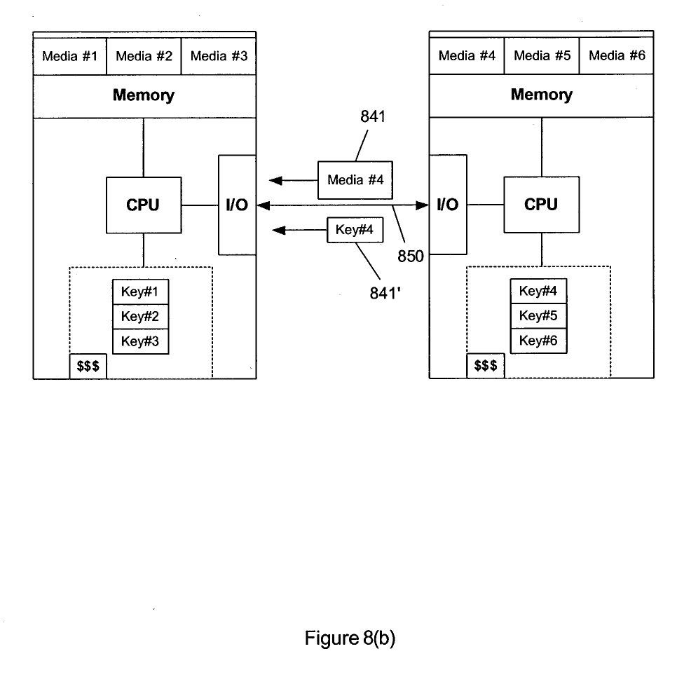

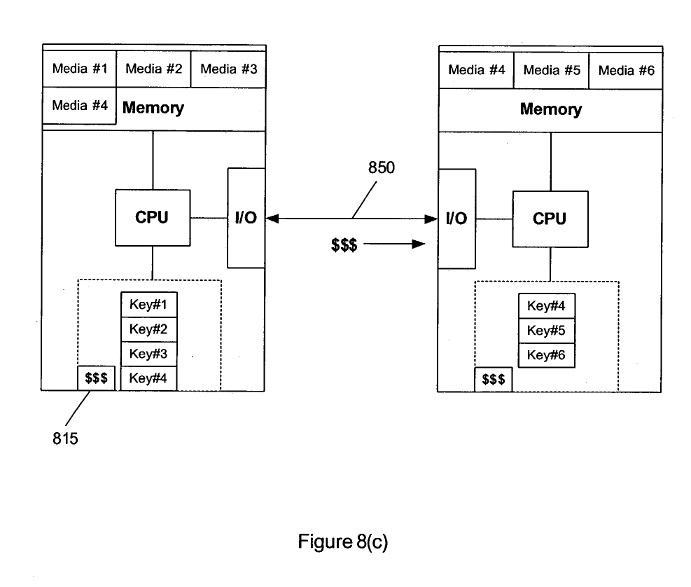

In another embodiment of the present invention, a user can utilize a media-playing device to transmit media files to another media-playing device in an offline fashion. FIG. 8(a) is an illustration in accordance with an alternate embodiment of the present invention. FIG. 8(a) shows a first MP3 player 810 and a second MP3 player 820. The first player 810 includes an inserted media card 811, a CPU 812, an I/O interface 813 and a memory 830. The memory 830 includes encrypted media files 831, 832, 833 and the media card 811 includes the associated decryption keys 831′, 832′, 833′ and a plurality of electronic tokens 815. Similarly, the second player 820 includes an inserted media card 821, a CPU 822, an I/O interface 823 and a memory 840. The memory 840 includes encrypted media files 841, 842, 843 and the media card 821 includes the associated decryption keys 841′, 842′, 843′ and a plurality of electronic tokens 825.

If a user of the first MP3 player 810 wants to add a media file from the second MP3 player 820, the first MP3 player 810 establishes a secure connection with the second MP3 player 820 via communication link 850. In an embodiment, communication link 850 is a wireless communication link. A secure connection between a first and second device can be established in a variety of ways, one of which is described in the co-pending patent application Serial No. (HPPDNO 100203932-1) entitled “Method and System for Providing Secure Communications Between a First and Second Peer Device” which is incorporated herein by reference.

Once the secure connection is established, the first and second MP3 players 810, 820 authenticate each other via the communication link 850. A request to download a media file, for example, media file 841, is then made by the first MP3 player 810. The second MP3 player 820 receives the request and transmits a copy of the encrypted media file 841 to the first MP3 player 810 along with the associated decryption key 841′. FIG. 8(b) shows the transmission of the media file 841 and the associated decryption key 841′ from the second MP3 player 820 to the first MP3 player 810 via communication link 850. Once the files are transmitted, the first MP3 player 810 transmits a portion of the digital tokens 815, to the second MP3 player 810 via communication link 850 in exchange for the files. FIG. 8(c) shows the transmission of the digital tokens from the first MP3 player 810 to the second MP3 player 820 via communication link 850. As can be seen in FIG. 8(c), the first MP3 player 810 now includes media file 841 and the media card 811 now includes the associated decryption key 841′.

Accordingly, system users can receive a pecuniary benefit based on the sharing of media files thereby encouraging users to share media files. Additionally, a portion of the transmitted tokens could be allocated for the media provider, e.g. Sony music, thus ensuring proper compensation to the media providers for the distribution of media. Therefore, intellectual property piracy associated with the exchange of digital media is essentially eliminated.

In an embodiment, the first and second MP3 players 810, 820 are peer devices. For the purposes of this patent application, a peer device is defined as a functional device that is on the same protocol layer as another device and is capable of communicating with the another device in a peer-to-peer fashion. Accordingly, one of ordinary skill in the art will readily recognize that a peer device, as utilized in conjunction with the present invention, could include a mobile phone, a watch, a laptop computer or a variety of other devices while remaining within the spirit and scope of the present invention.

As previously mentioned, in an embodiment, the communication link 850 is a wireless link. A wireless link is a link that comports with a wireless transmission protocol. An example of a wireless transmission protocol is the IEEE 802.11 or WiFi protocol. The 802.11 protocol is a family of IEEE standards for wireless LANs first introduced in 1997. The first standard was 802.11b, which specifies from 1 to 11 Mbps in the unlicensed 2.4 GHz band using direct sequence spread spectrum (DSSS) technology. Using the orthogonal FDM (OFDM) transmission method, there are two subsequent standards that provide from 6 to 54 Mbps: 802.11a transmits in the higher 5 GHz frequency range and is not backward compatible with the slower 802.11b; 802.11g works in the same range and is compatible.

An 802.11 system works in two modes. In “infrastructure mode,” wireless devices communicate to a wired LAN via access points. Each access point and its wireless devices are known as a Basic Service Set (BSS). An Extended Service Set (ESS) is two or more BSSs in the same subnet. In “ad hoc mode,” also known as “peer-to-peer mode,” wireless devices can communicate with each other directly and do not use an access point. This is an Independent BSS (IBSS). The speed of 802.11 systems is distance dependent. The farther away the remote device from the base station, the lower the speed.

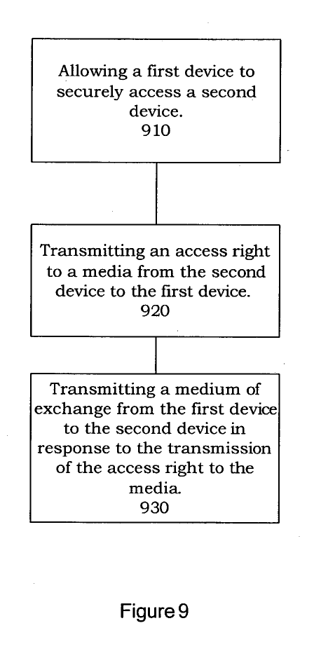

FIG. 9 is a flowchart in accordance with the above-described embodiment of the present invention. A first step 910 includes allowing a first device to securely access a second device. In an embodiment, step 910 involves the implementation of an authentication sequence. A second step 920 includes transmitting an access right to a media from the second device to the first device. In an embodiment, the access right is a decryption key for an associated encrypted media file. A final step 930 includes transmitting a medium of exchange from the first device to the second device in response to the transmission of the access right to the media. In an embodiment, the medium of exchange are digital tokens.

Although the above-described embodiment is described in the context of being implemented whereby the first and second devices are MP3 players, one of ordinary skill in the art will readily recognize that a variety of different devices could be employed while remaining within the spirit and scope of the present invention. For example, in another embodiment of the present invention, the first device could be an MP3 player and the second device could be a hot spot device as described in FIG. 4.

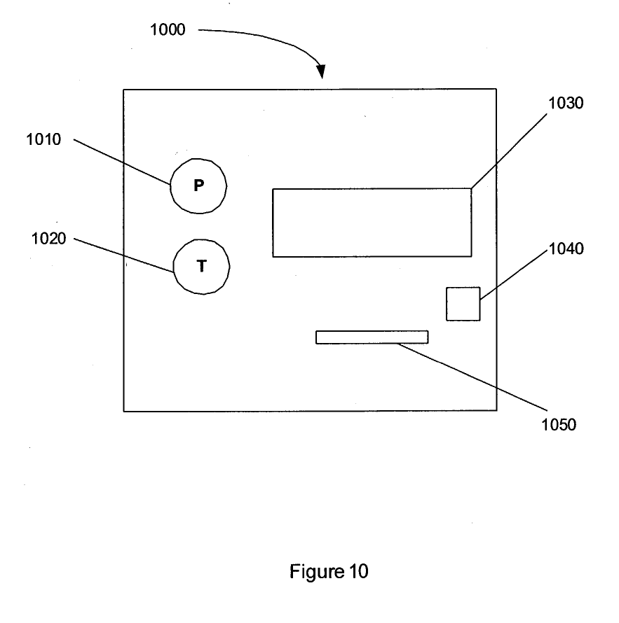

An alternate embodiment of the present invention involves the implementation of a car radio system whereby the media card is utilized in conjunction with a car audio system to purchase access rights to media files. FIG. 10 shows a car audio system 11000 in accordance with an embodiment of the present invention. The system 1000 includes a power knob 1010, a tuner knob 1020, a Liquid Crystal Display (LCD) screen 1030, a media card slot 1040 and a download button 1050. Accordingly, a media card (not shown) in accordance with the present invention can be inserted into the media card slot 1040 whereby a system user can purchase access rights to broadcasted digital media.

For example, suppose a system user is driving in her car listening to a radio station and she hears a song of particular interest to her and she wishes to download the access right to that song. The user simply inserts her media card into the media slot 1040 and depresses the download button 1050. In this embodiment, the access right is a decryption key to an encrypted copy of the media file containing the song of interest. Accordingly, when the user depresses the download button 1050, the decryption key to the song is downloaded to the media card. In an embodiment, the encrypted copy of the media file containing the song of interest is downloaded into an internal memory component (not shown) contained in the system 1000. Alternatively, the encrypted copy of the media file containing the song of interest can be downloaded with a separate media-playing device via the Internet or a hot spot. In any case, the user now has the decryption key that is needed to play the encrypted media file.

The above-described embodiments of the invention may also be implemented, for example, by operating a computer system to execute a sequence of machine-readable instructions. The instructions may reside in various types of computer readable media. In this respect, another aspect of the present invention concerns a programmed product, comprising computer readable media tangibly embodying a program of machine readable instructions executable by a digital data processor to perform the method in accordance with an embodiment of the present invention.

This computer readable media may comprise, for example, RAM (not shown) contained within the system. Alternatively, the instructions may be contained in another computer readable media such as a magnetic data storage diskette and directly or indirectly accessed by the computer system. Whether contained in the computer system or elsewhere, the instructions may be stored on a variety of machine readable storage media, such as a DASD storage (e.g. a conventional “hard drive” or a RAID array), magnetic tape, electronic read-only memory, an optical storage device (e.g., CD ROM, WORM, DVD, digital optical tape), or other suitable computer readable media including transmission media such as digital, analog, and wireless communication links. In an illustrative embodiment of the invention, the machine-readable instructions may comprise lines of compiled C, C++, or similar language code commonly used by those skilled in the programming for this type of application arts.

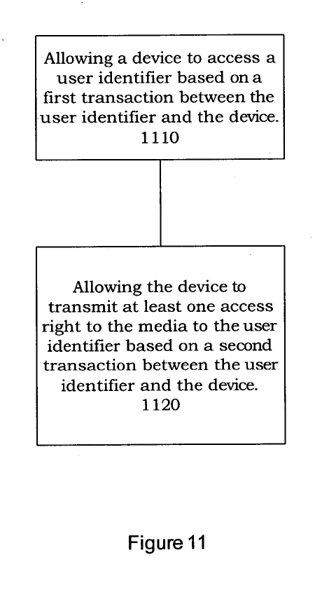

FIG. 11 is a flowchart of program instructions that could be contained within a computer readable medium in accordance with the alternate embodiment of the present invention. A first step 110 involves allowing a device to access a user identifier based on a first transaction between the user identifier and the device. In an embodiment, user identifier is a media card and the first transaction includes an authentication sequence. A final step 1120 involves allowing the device to transmit at least one access right to the media to the user identifier based on a second transaction between the user identifier and the device. In an embodiment, the media is an encrypted media file and the at least one access right to the media is a decryption key to the encrypted media file.

A method and system for exchanging digital media has been disclosed. According to the present invention, the method and system includes transmitting access rights between system users wherein the access rights allow access to certain types of transferable media. The access rights can be transmitted by paying a fee to the transmitting user. By utilizing the method and system in accordance with the present invention, system users are encouraged to share media, while at the same time, media providers can receive a fee for each transaction between system users thereby eliminating the theft of intellectual property rights related to the media.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method of exchanging digital media comprising:
receiving a user identifier;
securely accessing a device based on a first transaction between the user identifier and the device; and
allowing the device to transmit at least one access right to a media to the user identifier based on a second transaction between the user identifier and the device.

2. The method of claim 1 wherein the user identifier comprises a media card.

3. The method of claim 1 wherein the device comprises a hot spot.

4. The method of claim 1 wherein the device comprises a media playing device.

5. The method of claim 1 wherein the at least one access right comprises a license to use the media.

6. The method of claim 1 wherein the first transaction comprises an authentication of the user identifier.

7. The method of claim 6 wherein the user identifier includes a medium of exchange and the second transaction comprises transmitting the medium of exchange to the memory component of the device.

8. The method of claim 1 further comprising:
utilizing the user identifier to access the media via another device after completing the second transaction.

9. The method of claim 8 wherein the another device comprises a media playing device.

10. The method of claim 1 wherein the first and second transaction are conducted offline.

11. The method of claim 1 wherein allowing the device to transmit at least one access right to a media comprises allowing the device to transmit a decryption key to the media.

12. A system for exchanging digital media comprising:
a user identifier wherein the user identifier includes a memory portion;
a first device wherein the first device includes:
a first mechanism for accessing the memory portion of the user identifier; and
a memory component wherein the memory component includes at least one access right to a media; and
a second device wherein the second device includes a second mechanism for accessing the memory portion of the user identifier wherein the second device is capable of accessing the media.

13. The system of claim 12 wherein the user identifier comprises a media card.

14. The system of claim 12 wherein the first and second device comprise media playing devices.

15. The system of claim 14 wherein the first and second mechanisms each comprise a media card reader.

16. The system of claim 12 wherein the at least one access right comprises a license to use the media.

17. The system of claim 16 wherein license to use the media comprises a decryption key to the media.

18. The system of claim 12 wherein the second device comprises a hot spot.

19. A device for exchanging digital media comprising:
a memory component for storing at least one encrypted media file;
a media card reader coupled to the memory component; and
a central processing unit coupled to the memory component and the media card reader wherein the central processing unit includes logic for processing an access right to a media file based on a transaction between the media card reader and the central processing unit.

20. The device of claim 19 wherein the access right comprises a decryption key to the at least one encrypted media file.

21. The device of claim 20 wherein the transaction comprises:
determining if a media card is in the media card reader; and
accessing the decryption key from the media card if a media card is in the media card reader.

22. A method of purchasing digital media comprising:
allowing a first device to securely access a second device;
transmitting an access right to a media from the second device to the first device; and
transmitting a medium of exchange from the first device to the second device in response to the transmission of the access right to the media.

23. The method of claim 22 wherein the first and second devices are peer devices capable communicating in a peer-to-peer fashion.

24. The method of claim 22 wherein transmitting an access right to a media from the second device to the first device further comprises transmitting a decryption key to the media from the second device to the first device.

25. The method claim 22 wherein the second device comprises a hot spot.

26. The method of claim 22 wherein the first and second devices are media playing devices.

27. The method of claim 22 wherein the acts of transmitting an access right to a media and transmitting the medium of exchange are conducted offline.

28. A computer program product for exchanging media, the computer program product comprising a computer usable medium having computer readable program means for causing a computer to perform the steps of:
allowing a device to access a user identifier based on a first transaction between the user identifier and the device; and
allowing the device to transmit at least one access right to the media to the user identifier based on a second transaction between the user identifier and the device.

29. The computer program product of claim 28 wherein the user identifier comprises a media card.

30. The computer program product of claim 28 wherein the device comprises a hot spot.

31. The computer program product of claim 28 wherein the device comprises a media playing device.

32. The computer program product of claim 28 wherein the at least one access right comprises a license to use right.

33. The computer program product of claim 28 wherein the first transaction comprises an authentication of the user identifier.

34. The computer program product of claim 33 wherein the user identifier includes a medium of exchange and the second transaction comprises transmitting the medium of exchange to the device.
